(19) United States
(12) Patent Application Publication
(10) Pub. No.: US 2015/0023392 A1
(43) Pub. Date: Jan. 22, 2015

(54) BATTERY PACK

(71) Applicant: SAMSUNG SDI CO., LTD., Yongin-si (KR)

(72) Inventor: Kyoung-Hwan NOH, Yongin-si (KR)

(73) Assignee: SAMSUNG SDI CO., LTD., Yongin-si (KR)

(21) Appl. No.: 14/152,923

(22) Filed: Jan. 10, 2014

(30) Foreign Application Priority Data
Jul. 18, 2013 (KR) 10-2013-0084922

(51) Int. Cl. G01K 7/22

(52) U.S. Cl. CPC G01K 7/22
USPC 374/185

(57) ABSTRACT

A battery pack including at least one battery cell, and a thermistor configured to detect temperature information of the at least one battery cell, the thermistor including: a thermistor body; a fixation portion united with the thermistor body at a first side of the thermistor body and including a ring terminal; and a temperature measurement wire electrically connected to the thermistor body and extending from a second side of the thermistor body.

### CROSS-REFERENCE TO RELATED APPLICATION

This application claims priority to and the benefit of Korean Patent Application No. 10-2013-0084922, filed on Jul. 18, 2013 in the Korean Intellectual Property Office, the entire content of which is incorporated herein by reference.

### BACKGROUND

1. Field

Aspects of embodiments of the present invention relate to a battery pack.

2. Description of the Related Art

In general, secondary batteries are rechargeable, unlike primary batteries that are not rechargeable. Secondary batteries are used as energy sources, such as for mobile devices, electric automobiles, hybrid automobiles, electric bicycles, uninterruptible power supplies (UPSs), and the like. Depending on the types of external devices to which secondary batteries are applied, the secondary batteries may be used in the form of a single battery cell or in the form of a battery pack in which a plurality of battery cells are connected and packed into one unit.

Small-sized mobile devices, such as mobile phones, may operate for a certain time (e.g., a predetermined time) by using the power and capacity of a single battery. However, in the case of electric automobiles and hybrid automobiles, which involve large power consumption, long-time driving, and high-power driving, battery packs are preferred due to the problems of power and capacity. The output voltage or output current of a battery pack may increase as the number of battery cells included in the battery pack increases.

### SUMMARY

According to an aspect of embodiments of the present invention, a battery pack has a thermistor attachment structure that may sensitively capture a change in temperature of a battery cell.

Additional aspects of embodiments of the present invention will be set forth in part in the description which follows and, in part, will be apparent from the description, or may be learned by practice of the presented embodiments.

According to one or more embodiments of the present invention, a battery pack includes: at least one battery cell; and a thermistor configured to detect temperature information of the at least one battery cell, the thermistor including: a thermistor body; a fixation portion united with the thermistor body at a first side of the thermistor body and including a ring terminal; and a temperature measurement wire electrically connected to the thermistor body and extending from a second side of the thermistor body.

The thermistor body may include: a thermistor chip; and a chip case accommodating the thermistor chip.

The fixation portion may be united with the chip case.

The fixation portion may be formed of a same material as the chip case.

The fixation portion may be seamlessly connected with the chip case.

The thermistor chip may include a variable resistor having a resistance that varies with temperature.

The battery pack may further include a bus bar thermally contacting an electrode terminal of the at least one battery cell, and the fixation portion may be fixed on the bus bar.

The bus bar may electrically connect a pair of adjacent battery cells of the at least one battery cell.

The bus bar may have a screw hole, and the battery pack may further include a fastening member penetrating the fixation portion and fixed to the bus bar at the screw hole.

The bus bar may have a pair of terminal holes into which electrode terminals of a pair of adjacent battery cells are inserted.

The fixation portion may be fixed between the pair of terminal holes.

The fixation portion may be fixed at a position that is closer to one of the pair of terminal holes than to the other of the pair of terminal holes.

The battery pack may further include a voltage measurement wire connected to the electrode terminal to measure a voltage of the at least one battery cell.

The at least one battery cell may include a plurality of battery cells, and the thermistor may include thermistors arranged at respective pairs of adjacent battery cells of the plurality of battery cells.

The at least one battery cell may include electrode terminals at first and second sides of the battery pack, the battery pack may further include bus bars electrically connecting pairs of adjacent battery cells of the plurality of battery cells and arranged alternately at the first and second sides of the battery pack in an arrangement direction of the plurality of battery cells, and the thermistors may be attached to the bus bars at either one of the first and second sides of the battery pack.

The at least one battery cell may include a plurality of battery cells, and the battery pack may further include: a pair of end plates arranged at both ends in an arrangement direction of the battery cells; a pair of side plates covering both sides of the battery cells and connected to the pair of end plates; and a top plate arranged on surfaces of the battery cells including electrode terminals, the top plate being connected between the pair of end plates and between the pair of side plates.

The top plate may include: a base frame extending between the pair of end plates in the arrangement direction of the battery cells; and first and second support frames extending from the base frame to respective first and second side plates of the pair of side plates.

The battery pack may further include a plurality of bus bars configured to electrically connect the electrode terminals of adjacent battery cells of the plurality of battery cells, and the first and second support frames may extend in a space between the bus bars.

A wire guide may be formed on the top plate to guide the temperature measurement wire.

At least one of the side plates may include a boss member configured to attach a circuit board to which an extended end of the temperature measurement wire extending from the thermistor body is connected.

### BRIEF DESCRIPTION OF THE DRAWINGS

These and/or other aspects will become apparent and more readily appreciated from the following description of some embodiments of the present invention, taken in conjunction with the accompanying drawings, in which:

FIG. 1 is an exploded perspective view of a battery pack, according to an embodiment of the present invention;

FIG. 2 is a perspective view of an array of battery cells of the battery pack of FIG. 1;

FIG. 3 is a perspective view of a top plate of the battery pack of FIG. 1:

FIG. 4 is a top view of the battery pack of FIG. 1;

FIG. 5 is a top view showing a wire structure disposed on the top plate of the battery pack of FIG. 1;

FIGS. 6 and 7 are, respectively, a partial perspective view and an enlarged partial exploded perspective view showing portions of the battery pack shown in FIG. 5, and illustrating an attachment structure of a thermistor; and

FIGS. 8A and 8B are, respectively, a perspective view and a top view of a thermistor of a battery pack, according to an embodiment of the present invention.

### DETAILED DESCRIPTION

In the following detailed description, certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals refer to like elements throughout.

A battery pack according to an exemplary embodiment of the present invention is described below with reference to the accompanying drawings.

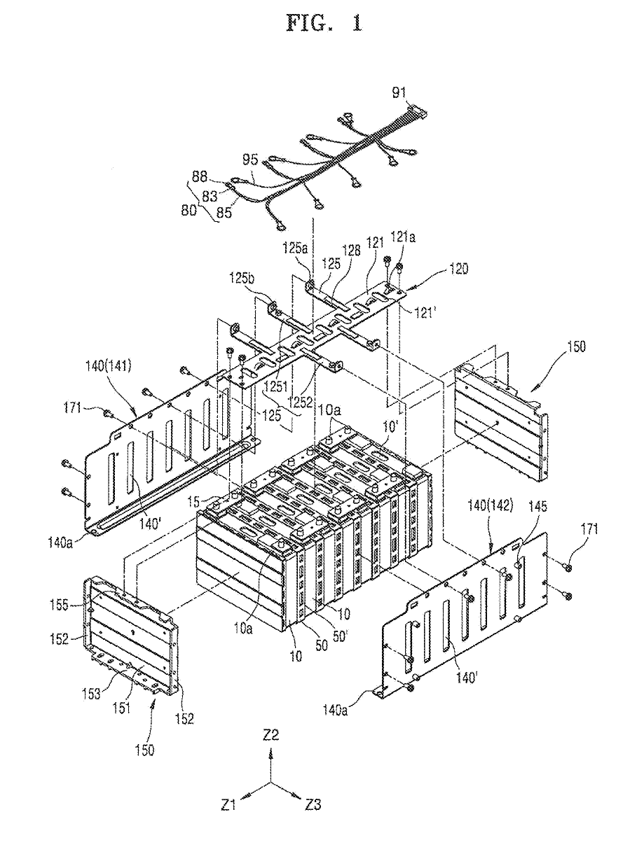

FIG. 1 is an exploded perspective view of a battery pack, according to an embodiment of the present invention. Referring to FIG. 1, the battery pack includes a plurality of battery cells 10 arranged in an array in a direction (e.g., a Z1 direction), and plates 120, 140, and 150 surrounding the array of battery cells 10. The battery pack includes wires 85 and 95 disposed on the battery cells 10. The wires 85 and 95, in one embodiment, include a temperature measurement wire 85 extending from a thermistor 80 attached on a bus bar 15, and a voltage measurement wire 95 connected to an electrode terminal 10a of the battery cell 10. State information of the battery cell 10 collected through the wires 85 and 95 may include a temperature measurement signal and a voltage measurement signal. The state information of the battery cell 10 may be transmitted to a battery management system (BMS) (not shown) to be used as data for determining whether a malfunction has occurred, such as overheating, overcharging, and over-discharging, or for detecting a degree of charge/discharge, such as a full charge. This is described in further detail later herein.

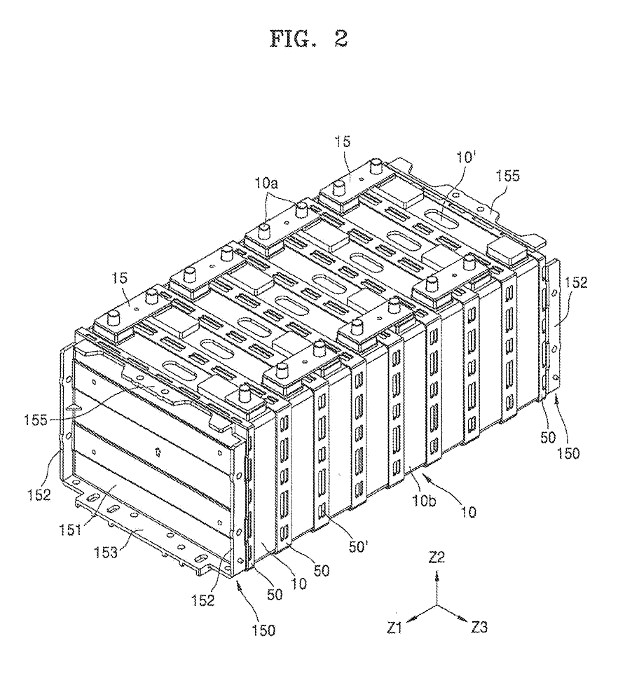

FIG. 2 is a perspective view of the array of battery cells 10 of the battery pack of FIG. 1. Referring to FIG. 2, the battery cell 10 may be a secondary battery, such as a lithium-ion battery, and may be any of various types of secondary batteries, such as a cylindrical secondary battery, a prismatic secondary battery, and a polymer secondary battery.

In one embodiment, for example, each of the battery cells 10 may include a case 10b, an electrode assembly (not shown) accommodated in the case 10b, and the electrode terminal 10a electrically connected to the electrode assembly and extracted outside the case 10b. For example, the electrode terminal 10a may form a top of the battery cell 10, and may be exposed on the case 10b. Although not illustrated in 2, the electrode assembly may include a positive electrode, a separator, and a negative electrode, and may be formed as a winding type or a stack type electrode assembly. The case 10b accommodates the electrode assembly therein, and the electrode terminal 10a is formed outside the case 10b, for electrical connection between the electrode assembly and an external circuit.

In one embodiment, for example, adjacent battery cells 10 may be electrically connected to each other through electrical connection between adjacent electrode terminals 10a, and may be connected in series or in parallel. The adjacent electrode terminals 10a may be connected to each other through the bus bar 15.

At least one safety vent 10′ may be formed in the case 10b. The safety vent 10′ may be designed to have a relatively low strength. When a certain pressure (e.g., a predetermined critical point or more of internal pressure) is applied inside the case 10b, the safety vent 10′ is broken to discharge internal gas.

A spacer 50 may be interposed between the adjacent battery cells 10. The spacer 50 may electrically insulate the adjacent battery cells 10. For example, the case 10b may have an electric polarity, and the spacer 50 may be formed of an insulating material and may be interposed between the adjacent battery cells 10 to block electrical interference between the adjacent battery cells 10.

The spacer 50 may provide a heat dissipation path between the adjacent battery cells 10. In one embodiment, a heat dissipation hole 50′ may be formed in the spacer 50. As is described further later herein, a heat dissipation hole 140′ may be formed at a side plate 140 assembled to cover a side of the spacer 50, and the heat dissipation hole 140′ of the side plate 140 and the heat dissipation hole 50′ of the spacer 50 formed at a corresponding position may be connected to each other to provide a heat dissipation path between the adjacent battery cells 10.

The spacer 50 may be interposed between the battery cells 10 to suppress thermal expansion (i.e. swelling) of the battery cell 10. The case 10b of the battery cell 10 may be formed of a deformable metal material. The spacer 50 may be formed of a less-deformable material, such as a polymer material, to suppress the swelling of the battery cell 10.

The spacer 50 may not only be disposed between the adjacent battery cells 10, but may also be disposed to contact an outside of an outermost cell 10 in the arrangement direction (e.g., the Z1 direction) of the battery cells 10. As illustrated in FIG. 2, an end plate 150 may be disposed at either side in the arrangement direction (e.g., the Z1 direction) of the battery cells 10, and one of the spacers 50 may be disposed between the end plate 150 and the outermost battery cell 10, for electrical insulation between the end plate 150 and the outermost battery cell 10.

A pair of the end plates 150 may be disposed on both sides in the arrangement direction (e.g., the Z1 direction) of the battery cells 10. One surface of the end plate 150 is disposed to face the outside of the outermost battery cell 10, and the surface of the end plate 150 may be assembled to contact the spacer 50 disposed outside the outermost battery cell 10.

The end plates 150 are provided to connect and pack a group of the battery cells 10 into one unit. The end plates 150 suppress the thermal expansion of the battery cells 10, which may be caused by a charge/discharge operation, and retain resistance characteristics, thereby preventing or substantially preventing a degradation in the electrical characteristics of the battery cells 10.

The end plate 150, in one embodiment, may include a base plate 151, and flanges 152, 153, and 155 that are bent from edges of the base plate 151 in a direction away from the battery cell 10. The base plate 151 may be formed to have a sufficient area to cover the outside of the battery cell 10.

The flanges 152, 153, and 155 are bent from the edges of the base plate 151 in the direction opposite to the battery cell 10. The flanges 152, 153, and 155, in one embodiment, may include a pair of side flanges 152 formed on both sides of the base plate 151, and bottom and top flanges 153 and 155 formed on the top and bottom of the base plate 151, respectively.

As illustrated in FIG. 1, the flanges 152, 153, and 155 may provide a connection position for connection between the end plate 150 and an adjacent component. For example, the flanges 152, 153, and 155 may facilitate connection of the end plate 150 to the side plate 140 and the top plate 120 that are assembled to contact each other along edges thereof. The flanges 152, 153, and 155 may also be configured to reinforce the mechanical rigidity of the end plate 150.

The side flange 152 may provide a connection position for facilitating the connection between the end plate 150 and the side plate 140, and an end of the side plate 140 laid on the side flange 152 may be connected to the side flange 152 through screw fastening. In one embodiment, a plurality of connection holes may be formed at the side flange 152.

The side plate 140 is disposed on sides of the battery cells 10. The side plate 140 is disposed to cover the sides of the battery cells 10 that are arranged in a direction. A pair of the side plates 140 may be disposed on both sides of the battery cells 10 that are opposite to each other. The side plate 140 may extend in the arrangement direction (e.g., the Z1 direction) of the battery cells 10, and both ends thereof may be respectively connected to the end plates 150 that are disposed on opposite sides. The side plate 140 may be screw-connected to the side flange 152 formed at a side edge of the end plate 150. After the side plate 140 and the side flange 152 are disposed to overlap each other and the connection holes are matched, the side plate 140 and the side flange 152 may be screw-connected by a fastening member such as a bolt and a nut. By the screw connection, the side plate 140 and the side flange 152 may form a surface contact by contacting each other in at least a portion thereof.

The side plate 140 may be formed to have a substantially plate shape, and may include a locking jaw 140a that is bent to support a portion of bottom surfaces of the battery cells 10. The side plates 140 disposed on the opposite side surfaces of the battery cells 10 may support the battery cells 10 at the bottom surfaces by a pair of respective locking jaws 140a that are bent in opposite directions.

The locking jaw 140a may extend throughout an overall length of the side plate 140 in the arrangement direction (e.g., the Z1 direction) of the battery cells 10. Opposite ends of the locking jaw 140a may be screw-connected to the bottom flanges 153 of the opposite end plates 150. In one embodiment, connection holes may be formed at the locking jaw 140a and the bottom flange 153. After the connection holes are matched, the side plate 140 and the end plate 150 may be screw-connected by a fastening member that is fastened to penetrate the locking jaw 140a and the bottom flange 153. The locking jaw 140a and the bottom flange 153 may surface-contact each other at a corner position of the battery pack. In this manner; the side plate 140 may be fastened to the bottom flange 153 and the side flange of 152 of the end plate 150, and may form an accommodation space for accommodating the array of the battery cells 10.

The heat dissipation hole 140′ may be formed at the side plate 140. In one embodiment, a plurality of the heat dissipation holes 140′ may be formed at intervals (e.g., predetermined intervals) in the arrangement direction (e.g., the Z1 direction) of the battery cells 10. The heat dissipation hole 140′ allows the contact between the battery cell 10 and an external device, thereby making it possible to rapidly discharge driving heat generated from the battery cell 10.

In one embodiment, with the exception of a portion supported by the locking jaw 140a of the side plate 140, the bottom of the battery cell 10 may be exposed from the side plate 140. External air may be allowed to flow between the battery cells 10 through the bottom of the battery cell 10 exposed from the side plate 140, and the heat dissipation of the battery cells 10 may be accelerated.

A boss member 145 for attachment of a circuit board (not shown) may be formed at the side plate 140. For example, the circuit board may form the BMS. One surface of the side plate 140 may face the sides of the battery cells 10, and a circuit board may be attached to an opposite surface of the side plate 140. For example, the circuit board may be configured to monitor a charge/discharge state of the battery cell 10 and control an overall charge/discharge, operation of the battery pack.

In one embodiment, for example, the boss member 145 may be disposed at four positions in a lattice configuration, corresponding to a substantially rectangular circuit board or a rectangular circuit board, and may be disposed at a multiple of four positions, corresponding to a plurality of circuit boards. Although not illustrated, a connection hole may be formed in the circuit board, and a screw member penetrating the connection hole may be fastened to the boss member 145 on the side plate 140 to fix the circuit board on the side plate 140.

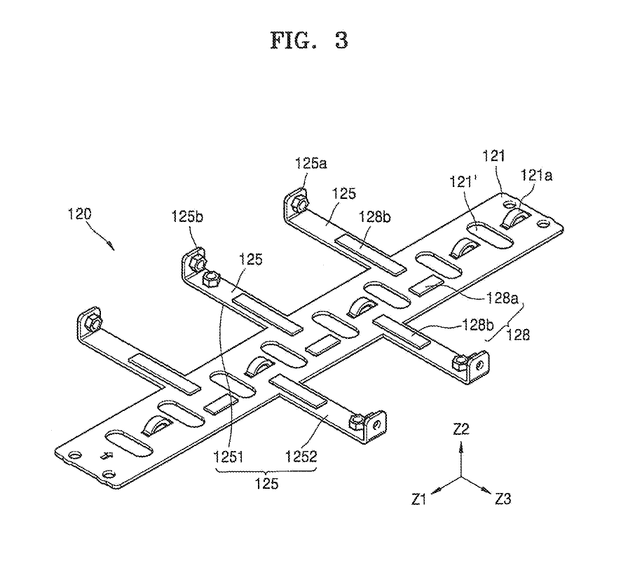

FIG. 3 is a perspective view of the top plate 120. Referring to FIGS. 1 and 3, the top plate 120 is disposed on the battery cells 10 (e.g., in a Z2 direction). The top plate 120 may include a base frame 121 extending across a top central portion of the battery cells 10 in the arrangement direction (e.g., the Z1 direction) of the battery cells 10, and a support frame 125 extending from the base frame 121 to the side plates 140.

At least one opening 121′ may be formed at a position corresponding to the safety vent 10′ of the battery cell 10 in the longitudinal direction of the base frame 121. Both ends of the base frame 121 may be fastened to the end plates 150 arranged at the opposite sides of the battery cells 10. The base frame 121 may be screw-connected to the top flange 155 formed at a top edge of the end plate 150. After the base frame 121 and the top flange 155 are disposed to overlap each other and the connection holes are matched, the base frame 121 and the top flange 155 may be screw-connected by a fastening member such as a bolt and a not. By the screw connection, the base frame 121 and the top flange 155 may form a surface contact by contacting each other in at least a portion thereof.

The base frame 121 supports the end plates 150 disposed at both ends in the arrangement direction (e.g., the Z1 direction) of the battery cells 10, and maintains a predetermined space between the end plates 150, thereby making it possible to suppress expansion of the battery cells 10 in the arrangement direction (e.g., the Z1 direction) and prevent or substantially prevent the degradation of charge/discharge characteristics caused by the deformation of the battery cells 10.

The support frame 125 is connected to the side plates 140 across the top of the battery cells 10 in a direction (e.g., a Z3 direction) intersecting the base frame 121, for example, a vertical direction of the base frame 121. The support frame 125 may be integral with the base frame 121.

In one embodiment, the support frame 125 includes one end extended from the base frame 121, and the other end extending away from the one end and fastened to the side plate 140. For example, one end of the support frame 125 may extend integrally from the base frame 121, and the other end of the support frame 125 may be screw-fastened to the side plate 140. In one embodiment, the other end of the support frame 125 may include a bent portion 125a that is bent to face the side plate 140 and is laid on, or overlaps in surface contact with, the side plate 140.

The side plate 140 and the bent portion 125a may be connected to overlap each other, and a connection fastening member 125b may be formed at the bent portion 125a. For example, after positions of the connection fastening member 125b and the connection hole of the side plate 140 are aligned, a through fastening member 171 (see FIG. 1) penetrating the side plate 140 may be connected to the connection fastening member 125b to provide the fastening between the side plate 140 and the support frame 125.

In one embodiment, for example, the through fastening member 171 and the connection fastening member 125b may include a bolt and a nut, respectively. The through fastening member 171 may penetrate the side plate 140 and the support frame 125, which overlap each other, and may be connected to the connection fastening Member 125b fixed to the support frame 125. In another embodiment, the bent portion 125a of the support frame 125 may be connected to the side plate 140 by welding, instead of by screw connection.

The base frame 125 supports the side plates 140 disposed at both sides of the battery cells 10, and maintains a predetermined space between the side plates 140, thereby making it possible to suppress expansion of the battery cells 10 in the lateral direction and prevent or substantially prevent the degradation of charge/discharge characteristics caused by the deformation of the battery cells 10.

For example, the battery cells 10 may be assembled by being pressed in the arrangement direction (e.g., the Z1 direction) by the base frame 121 or the end plates 150. The battery cells 10 may be expanded by the pressing pressure, and thus the side plate 140 may be deformed to be bent convexly.

The support frame 125 combines the side plates 140, which are disposed at both sides of the battery cells 10, with each other at several positions to press the battery cells 10 in the lateral direction (e.g., the Z3 direction), thereby making it possible to prevent or substantially prevent the side plate 140 from being bent convexly by the expansion of the battery cell 10. The deformation of the battery cells 10 may degrade the charge/discharge characteristics thereof. Therefore, the charge/discharge characteristics may be maintained by preventing or substantially preventing the deformation of the battery cells 10.

The support frame 125 may provide mechanical rigidity for resisting shaft torsion and shaft rotation with respect to a center of rotation in the arrangement direction (e.g., the Z1 direction) of the battery cells 10. That is, the support frame 125 may support a predetermined space between first and second side plates 141 and 142 of the pair of side plates 140, thereby providing sufficient rigidity for resisting the torsion and rotation of the battery pack.

The support frame 125 may include a first support frame 1251 extending from one side of the base frame 121 toward the first side plate 141, and a second support frame 1252 extending from the other side of the base frame 121 toward the second side plate 142. The first and second support frames 1251 and 1252 may extend from the opposite sides of the base frame 121, and may be formed at alternating positions in the longitudinal direction (e.g., the Z1 direction) of the base frame 121.

At least one bead 128 may be formed on the top plate 120. The bead 128 may be attached on the base frame 121 and the support frame 125, and may serve to supplement the mechanical rigidity of the top plate 120.

The top plate 120 supports a predetermined space between the pair of side plates 141 thereby suppressing the expansion of the battery cell 10 and providing mechanical rigidity for resisting shaft torsion and shaft rotation with respect to a center of rotation in the arrangement direction (e.g., the Z1 direction) of the battery cells 10. The bead 128 may supplement the rigidity of the top plate 120 to provide sufficient rigidity for resisting the expansion (i.e. swelling) of the battery cells 10 or the shaft torsion and shaft rotation of the battery pack.

In one embodiment, for example, the bead 128 may include a first bead 128a formed on the base frame 121, and a second bead 128b formed across a boundary between the base frame 121 and the support frame 125. A plurality of the first beads 128a may be arranged along the base frame 121 and may be formed between the openings 121′. The first bead 128a may extend along the base frame 121 to provide the structural rigidity in the longitudinal direction (e.g., the Z1 direction) of the base frame 121.

The second bead 128b may extend from on the base frame 121 to on the support frame 125. The second bead 128h may extend in a longitudinal direction (e.g., the Z3 direction) of the support frame 125 to provide the structural rigidity in the longitudinal direction of the support frame 125.

In one embodiment, for example, the first and second beads 128a and 128b may extend in the longitudinal direction of the base frame 121 and the longitudinal direction of the support frame 125, respectively, to provide the rigidity in the respective longitudinal directions, thereby maintaining a predetermined space between the pair of end plates 150 and between the pair of side plates 140 and suppressing the expansion or torsion deformation of the battery cells 10.

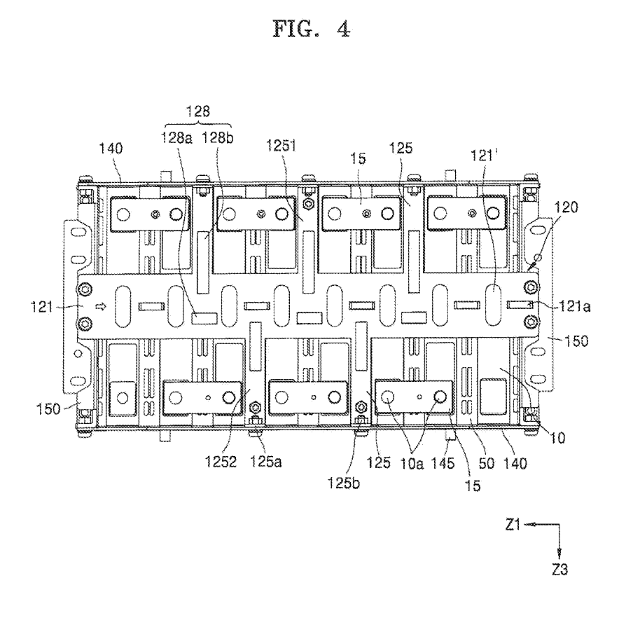

FIG. 4 is top view of the battery pack of FIG. 1. Referring to FIG. 4, a group of the battery cells 10 forming the battery pack may be electrically connected by the bus bars 15, and may be connected in series, for example. The bus bars 15 electrically connect different pairs of battery cells 10. The bus bar 15 may be inserted into a protrusion portion Of the electrode terminal 10a, or may be connected on the electrode terminal 10a, such as by welding. In one embodiment, a plurality of the bus bars 15 may be assembled at alternate positions on the left and right sides (e.g., ±Z3 directions) to connect the group of battery cells 10 sequentially in the arrangement direction (e.g., the Z1 direction) of the battery cells 10.

The top plate 120 may be disposed on the battery cells 10, together with the bus bars 15. The bus bars 15 and the top plate 120 may be formed at different positions so as not to cause mechanical/electrical interference therebetween.

In one embodiment, the bus bar 15 extends in a direction (e.g., the Z1 direction) to connect a pair of adjacent battery cells 10, and a plurality of the bus bars 15 are disposed to connect different pairs of the battery cells 10. In one embodiment, the support frame 125 of the top plate 120 is disposed in a space between the bus bars 15, thereby avoiding an interference with the bus bars 15. In one embodiment, for example, the support frame 125 may include the first and second support frames 1251 and 1252 that extend in opposite directions from the base frame 121. The first and second support frames 1251 and 1252 may be formed at alternating positions in the longitudinal direction (e.g., the Z1 direction) of the base frame 121, and a number of the first and second support frames 1251 and 1252 may be determined according to the arrangement of the bus bars 15.

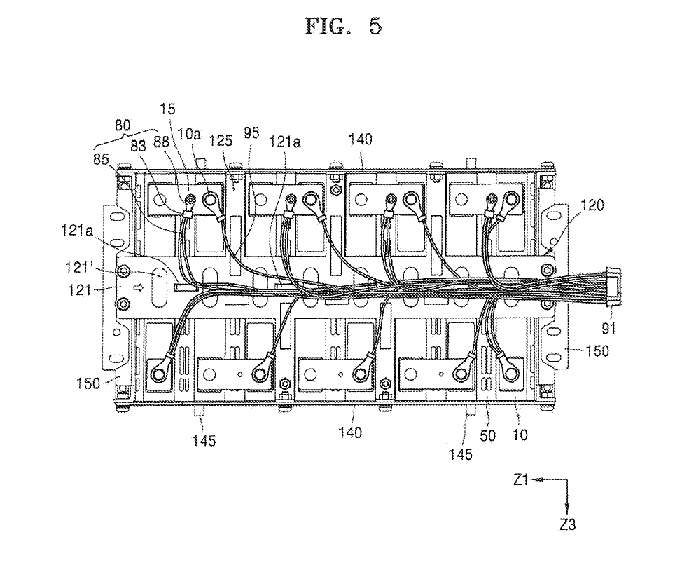

FIG. 5 is a top view showing a wire structure disposed on the top plate 120. Referring to FIG. 5, the top plate 120 may guide the wires 85 and 95 from the bus bars 15 or the electrode terminals 10a of the respective battery cells 10. In one embodiment, for example, the wires 85 and 95 may include a plurality of wires 85 and 95 that are extracted from the bus bars 15 or the electrode terminals 10a distributed at a plurality of positions. The plurality of wires 85 and 95 may extend to transmit state information of the battery cells 10, such as voltage measurement information or temperature measurement information, to the BMS (not shown).

In one embodiment, for example, one end of each of the wires 85 and 95 may be connected to the electrode terminal 10a or the bus bar 15, and the other end thereof may be connected to the BMS. In one embodiment, the plurality of wires 85 and 95 may be combined through at least one wire guide 121a, which is formed at the top plate 120, to form an extended path toward the BMS.

Referring to FIGS. 3 and 5, the wire guide 121a may be united or integral with the top plate 120, such as on the base frame 121, and may be formed, for example, as a ring-shaped part formed on the base frame 121. In one embodiment, for example, the wire guides 121a may be arranged in a line in an extension direction of the base frame 121, and may form an extended path of the wires 85 and 95 in the arrangement direction. For example, the wires 85 and 95 may extend in the arrangement direction (e.g., the Z1 direction) of the battery cells 10.

A tie member (not shown) may be connected to the wire guide 121a to tie the plurality of wires 85 and 95, and the wires 85 and 95 connected by the tie member may be united in one unit for easy handling. For example, the tie member may be formed of an insulating plastic material, and may be a flexible wire. The wires 85 and 95 connected to the wire guides 121a arranged in a line may extend along the extended path toward the BMS, and a connector 91 may be provided at an extended end thereof.

In one embodiment, for example, the wires 85 and 95 may include a voltage measurement wire 95 connected to the electrode terminal 10a of the battery cell 10, and a temperature measurement wire 85 connected to the bus bar 15. The voltage measurement wire 95 may transmit a voltage measurement signal of each battery cell 10 to the BMS. The temperature measurement wire 85 may transmit a temperature measurement signal, which is output from the thermistor 80, to the BMS.

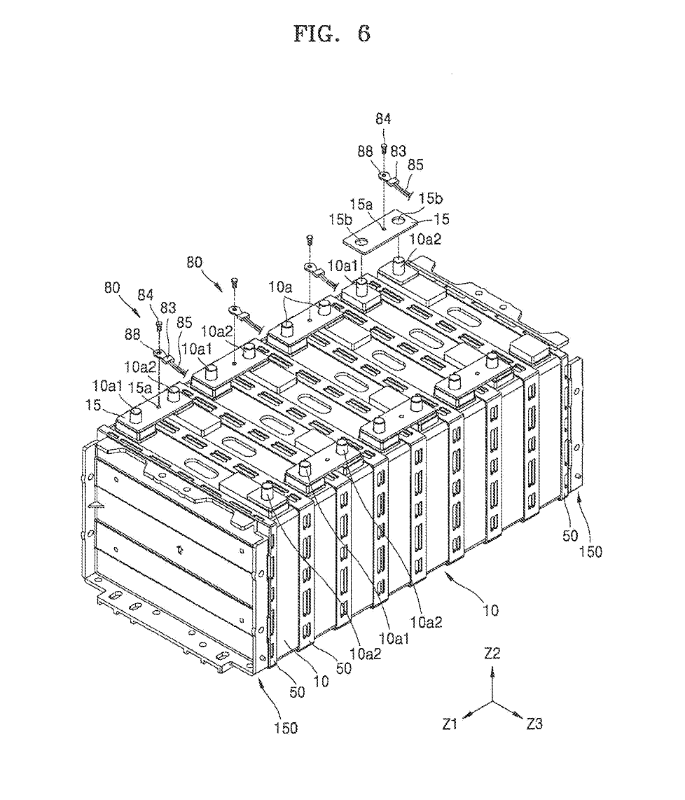

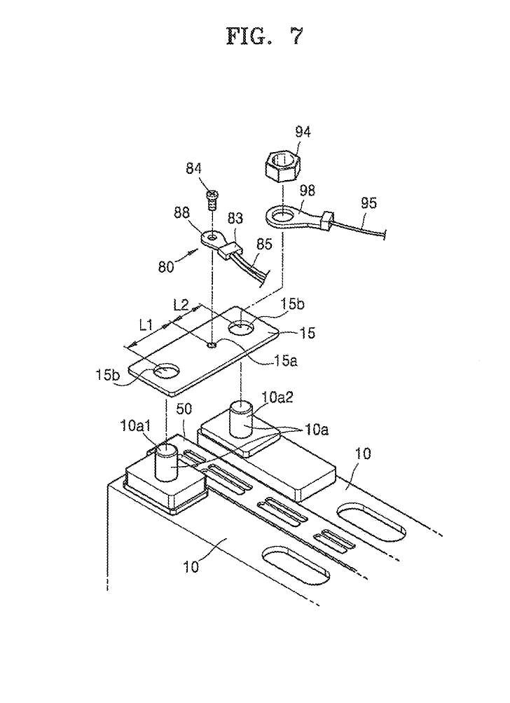

FIGS. 6 and 7 are, respectively, a partial perspective view and an enlarged partial exploded perspective view showing portions of the battery pack shown in FIG. 5, and illustrating an attachment structure of the thermistor 80. Referring to FIGS. 6 and 7, the battery pack includes at least one thermistor 80 configured to measure the temperature of the battery cell 10. The thermistor 80 may be disposed at a close position to the battery cell 10, and may be attached, for example, on the bus bar 15 configured to connect a pair of adjacent battery cells 10. The bus bar 15 may thermally contact the battery cell 10 to transmit the temperature of the battery cell 10 to the thermistor 80. However, the attachment position of the thermistor 80 is not limited to the bus bar 15, and the thermistor 80 may be attached at any position of the battery pack as long as a thermal contact with the battery cell 10 is formed to transmit temperature information of the battery cell 10 to the thermistor 80.

The thermistor 80 may convert temperature information of a measurement position into an electrical signal and transmit the electrical signal to the BMS. The thermistor 80 generates a voltage signal corresponding to the temperature of a measurement target, and may be implemented by a resistive temperature sensor that has an electrical resistance varying with temperature.

A plurality of thermistors 80 may be provided and may include as many as the number of temperatures to be sensed. For example, since a temperature difference may occur according to measurement positions in the battery pack including a plurality of battery cells, temperatures may be measured at a plurality of different positions to detect accurate temperature information of each battery cell 10 or each pair of battery cells 10.

An attachment position of the thermistor 80 according to an embodiment of the present invention will be described below with reference to FIGS. 6 and 7. In one embodiment, the thermistor 80 may be attached on the bus bar 15. The bus bar 15 may electrically connect a pair of adjacent battery cells 10, and the thermistor 80 attached on the bus bar 15 may detect the temperature of the pair of battery cells 10, for example, an average temperature of the pair of the battery cells 10.

For example, since a temperature difference may occur according to measurement positions in the battery pack including the plurality of battery cells 10, a plurality of the thermistors 80 may be attached at a plurality of different measurement positions. In this case, when a dedicated thermistor 80 is attached to each battery cell 10 to detect the temperature of each battery cell 10, the complexity of processes and costs for attachment of the thermistors 80 may increase greatly. Therefore, while thermistors 80 are attached to a plurality of measurement positions to detect the accurate driving states of the battery cells 10, one piece of temperature information may be measured with respect to each pair of adjacent battery cells 10, thereby reducing the attachment cost of the thermistors 80 and simplifying the manufacturing process thereof. That is, the thermistor 80 may detect one piece of temperature information with respect to each pair of adjacent battery cells 10.

In one embodiment, the battery cell 10 may include a pair of electrode terminals 10a on the left and right sides (e.g., the ±Z3 directions). The electrode terminals 10a may protrude upward from the battery cell 10. For example, the battery cell 10 may include a positive terminal 10a1 and a negative terminal 10a2, which have opposite polarities, on the left and right sides (e.g., the ±Z3 directions). In this case, a plurality of bus bars 15 may be disposed at alternate positions on the left and right sides (e.g., the ±Z3 directions) in the arrangement direction (e.g., the Z1 direction) of the battery cells 10 to connect the electrode terminals 10a of adjacent battery cells 10. In one embodiment, the thermistors 80 may be selectively attached to only one of the left and right bus bars 15. For example, the thermistors 80 may be attached to the left (e.g., the −Z3 direction) bus bar 15 and may not be attached to the right (e.g., the +Z3 direction) bus bar 15.

In one embodiment, for example, the thermistors 80 may be selectively attached to only one of the left and right bus bars 15 such that one thermistor 80 is allocated to each pair of adjacent battery cells 10. Since a suitable number or more of measurement positions are secured, an erroneous temperature detection caused by a temperature difference may be prevented or substantially prevented, and the number of thermistors 80 may be reduced and the assembly process thereof may be simplified.

The bus bar 15 may be assembled on a pair of electrode terminals 10a of adjacent battery cells 10 to electrically connect the adjacent battery cells 10. In one embodiment, for example, the bus bar 15 may connect the positive and negative terminals 10a1 and 10a2 of a pair of adjacent battery cells 10, which have different polarities, to connect the pair of adjacent battery cells 10 in series. In another embodiment of the present invention, the bus bar 15 may connect the electrode terminals 10a of a pair of adjacent battery cells 10, which have the same polarity, to connect the pair of adjacent battery cells 10 in parallel. In one embodiment, as illustrated in FIG. 6, the bus bar 15 may connect the positive terminal 10a1 and the negative terminal 10a2 of adjacent battery cells 10. For this serial connection, a plurality of bus bars 15 may be disposed at alternate positions on the left and right sides (e.g., the ±Z3 directions) according to the arrangement of the battery cells 10 arranged in a line.

The bus bar 15 may form a thermal contact at a close position with the electrode terminal 10a of the battery cell 10. A charge current to the battery cell 10 and a discharge current from the battery cell 10 are concentrated, and thus generated heat is concentrated locally at the electrode terminal 10a. Therefore, the temperature of the bus bar 15, which thermally contacts the electrode terminal 10a, may be detected to sensitively capture temperature information of the battery cell 10. For example, whether the battery cell 10 is overheated may be determined based on the temperature information of the battery cell 10 detected from the thermistor 80, and the charge/discharge operation of the battery cell 10 may be controlled based on this determination. Therefore, in one or more embodiments of the present invention, whether the battery cell 10 is overheated may be sensitively captured by measuring the temperature of the electrode terminal 10a where a relatively large amount of heat is concentrated.

In one embodiment, a pair of terminal holes 15b, where the electrode terminals 10a of adjacent battery cells 10 are assembled, are formed at the bus bar 15. The electrode terminal 10a of the battery cell 10 may be inserted into the bus bar 15 through the terminal hole 15b.

The thermistor 80 may be attached on the bus bar 15. The thermistor 80 may be attached between the pair of terminal holes 15b formed at the bus bar 15. In one embodiment, for example, a screw hole 15a may be formed between the pair of terminal holes 15b, and the thermistor 80 may be attached on the bus bar 15 via a fastening member 84 that is inserted into the screw hole 15a through the thermistor 80.

The thermistor 80 may detect one piece of temperature information from one pair of electrode terminals 10a inserted into the bus bar 15. Referring to FIG. 7, the thermistor 80 may be attached at a position that is closer to one of the pair of terminal holes 15b. In one embodiment, with respect to the screw hole 15a to which the thermistor 80 is attached, a second distance L2 between the screw hole 15a and the terminal hole 15b through which the negative terminal 10a2 is inserted may be smaller than a first distance L1 between the screw hole 15a and the terminal hole 15b through which the positive terminal 10a1 is inserted, because heat generation of the battery cell 10 may be more concentrated at the negative terminal 10a2 than at the positive terminal 10a1. That is, the overheating of the battery cell 10 may be sensitively captured by disposing the thermistor 80 at a position that is closer to the negative terminal 10a2 where heat generation is more concentrated.

The voltage measurement wire 95 may be connected to the electrode terminal 10a of the battery cell 10. The voltage measurement wire 95 may transmit a voltage measurement signal of the battery cell 10 to the BMS, which may be used as data for controlling the charge/discharge operation of the battery cell 10. In one embodiment, the voltage measurement wire 95 may be connected to each battery cell 10 to detect a malfunction (e.g., overcharge or over-discharge) of each battery cell 10. In one embodiment, a connection terminal 98 may be formed at a front end of the voltage measurement wire 95, and the connection terminal 98 may be pressed and closely attached on the electrode terminal 10a or the bus bar 15 through a fastening member 94, so that the voltage measurement wire 95 may be fixed to the electrode terminal 10a. In one embodiment, for example, the connection terminal 98 may be implemented by a ring terminal having a through hole into which the electrode terminal 10a may be inserted.

The voltage measurement wire 95 connected to the electrode terminal 10a, and the temperature measurement wire 85 fixed on the bus bar 15 may be combined at one side of the battery pack through the wire guide 121a formed on the top plate 120. An extended end of the temperature measurement wire 85 and the voltage measurement wire 95 may be connected to the BMS. For example, the BMS may collect state information of the battery cell 10 through the temperature measurement wire 95 and the voltage measurement wire 85, determine whether the battery cell 10 is overheated, based on the collected state information, and detect a degree of charge/discharge, such as a full charge.

The BMS may include a circuit board (not shown) fixed to the side plate 140. As illustrated in FIG. 1, the boss member 145 protruding in the lateral direction may be formed at the side plate 140, and the circuit board may be fixed on the side plate 140 through a fastening member that is fastened to the boss member 145 through a through hole of the circuit board.

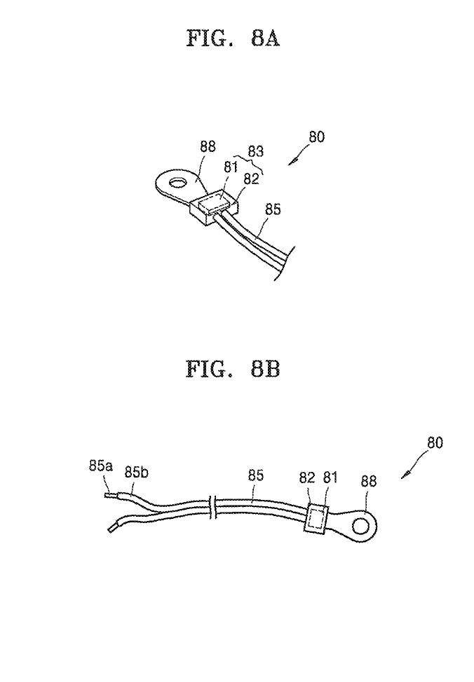

FIGS. 8A and 8B are, respectively, a perspective view and a top view of the thermistor 80 according an embodiment of the present invention. Referring to FIGS. 8A and 8B, the thermistor 80, in one embodiment, includes a thermistor body 83 configured to convert a temperature signal into an electrical signal, a fixation portion 88 formed at a front of the thermistor body 83, and a temperature measurement wire 85 formed at a rear of the thermistor body 83.

The thermistor body 83, in one embodiment, may include a thermistor chip 81, and a chip case 82 accommodating the thermistor chip 81. The thermistor chip 81 may be implemented by a variable resistor that has a resistance varying with a temperature of a measurement target. The chip case 82 may accommodate the thermistor chip 81 to protect the thermistor chip 81 from an external impact or a foreign material. The chip case 82 may form a heat transmission path between the thermistor chip 81 and a measurement target, and may include a material having high thermal conductivity, such as a metal material. In one embodiment, the chip case 82 may further include an electrically insulating coating (not illustrated) that is coated on a metal skeleton to perform an electrically insulating function.

A temperature measurement wire 85 may be connected to the rear of the thermistor body 83 to receive external driving power and transmit an electrical temperature signal to the outside. In one embodiment, for example, the temperature measurement Wire 85 may be formed as a pair to measure the voltage of both terminals of the thermistor chip 81. The temperature measurement wire 85 may sense a temperature change by detecting a change in the electrical resistance of the thermistor chip 81 according to a temperature change. For example, a resistance change between both terminals of the thermistor chip 81 may be captured by the voltage division by a reference resistor (not shown), together with the thermistor chip 81. However, a driving method for sensing a resistance change in the thermistor chip 81 is not limited thereto, and may be modified variously according to embodiments of the present invention.

The temperature measurement wire 85 may transmit an electrical temperature signal, which is generated from the thermistor chip 81, to the BMS. The temperature measurement wire 85 may form a portion of a wire for transmitting state information of the battery cell 10. The temperature measurement wire 85 may include a core 85a configured to transmit an electrical signal, and an insulating coating 85b configured to insulate the core 85a from external environments.

The fixation portion 88 configured to closely fix the thermistor 80 to a measurement target may be formed at the front of the thermistor body 83. In one embodiment, the fixation portion 88 may be implemented by a ring terminal that provides a through hole through which the fastening member 84 (see FIG. 7) may be inserted. For example, the fixation portion 88 may be closely fixed to the measurement target by being pressed by the fastening member 84 fastened to the measurement target through the through hole.

Together with the chip case 82, the fixation portion 88 may transmit temperature information of the measurement target to the thermistor chip 81, and may increase the thermal contact area with the measurement target. For example, together with the chip case 82, the fixation portion 88 may form a large area of thermal contact with the measurement target, may rapidly transmit a temperature change of the measurement target, which changes according to a charge/discharge operation, and may transmit accurate temperature information to the thermistor chip 81 in real time by forming a thermal equilibrium with the measurement target within a short time.

As illustrated in FIG. 7, the fixation portion 88 may be fixed on the bus bar 15 configured to electrically connect a pair of adjacent battery cells 10. In one embodiment, the screw hole 15a for screw connection of the fastening member 84 may be formed at the bus bar 15. The fastening member 84 may be inserted into the screw hole 15a formed at the bus bar 15 through a through hole of the fixation portion 88, and the fixation portion 88 may be closely fixed on the bus bar 15 by the fastening member 84.

The fixation portion 88 may be formed at a close position contacting the thermistor body 83. The thermistor body 83 is configured to convert temperature information into an electrical signal, and may closely contact the measurement target. In one embodiment, since the fixation portion 88 and the thermistor body 83 are disposed at a close contact position, a pressing fastening force through the fixation portion 88 may be transmitted to the thermistor body 83, such that the thermistor body 83 may closely contact the measurement target effectively. In one embodiment, the fixation portion 88 and the thermistor body 83 are united with each other, and the pressing fastening force of the fixation portion 88 causes the thermistor body 83 to contact the measurement target more closely.

The fixation portion 88 may be united with the thermistor body 83. For example, the fixation portion 88 may be united with the chip case 82 of the thermistor body 83. The fixation portion 88 and the chip case 82 may be seamlessly connected to each other, or may be connected to each other by a fixed connection such as by welding or soldering. Herein, the term “fixed connection” is used to mean that the components are connected such that they cannot be separated from each other without being damaged.

According to an embodiment of the present invention, the fixation portion 88 and the chip case 82 may include the same material, for example, the same metal material. The fixation portion 88 and the chip case 82 may thermally contact the measurement target to transmit temperature information of the measurement target to the thermistor chip 81. In this case, when the fixation portion 88 and the chip case 82 are formed of a metal material having excellent thermal characteristics, a thermal equilibrium is rapidly formed between the fixation portion 88 and the chip case 82, thereby making it possible to transmit accurate temperature information to the thermistor chip 81 without thermal leakage due to a temperature difference between the fixation portion 88 and the chip case 82. In one embodiment, for example, the fixation portion 88 and the chip case 82 may further include a metal skeleton, and an insulating coating (not shown) that is coated on the metal skeleton to perform an insulating function.

As described above, according to the one or more of the above embodiments of the present invention, it is possible to provide battery packs having a thermistor attachment structure that may sensitively capture a change in the temperature of a battery cell, which changes according to a charge/discharge operation, and may rapidly detect a malfunction such as overheating.

While the present invention has been described in connection with certain exemplary embodiments, it is to be understood that the invention is not limited to the disclosed embodiments. Accordingly, it will be understood by those of skill in the art that various changes in form and details may be made without departing from the spirit and scope of the present invention as set forth in the following claims and equivalents thereof.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A battery pack comprising:
at least one battery cell; and
a thermistor configured to detect temperature information of the at least one battery cell, the thermistor comprising:
a thermistor body;
a fixation portion united with the thermistor body at a first side of the thermistor body and comprising a ring terminal; and
a temperature measurement wire electrically connected to the thermistor body and extending from a second side of the thermistor body.

2. The battery pack of claim 1, wherein the thermistor body comprises:
a thermistor chip; and
a chip case accommodating the thermistor chip.

3. The battery pack of claim 2, wherein the fixation portion is united with the chip case.

4. The battery pack of claim 3, wherein the fixation portion is formed of a same material as the chip case.

5. The battery pack of claim 3, wherein the fixation portion is seamlessly connected with the chip case.

6. The battery pack of claim 2, wherein the thermistor chip comprises a variable resistor having a resistance that varies with temperature.

7. The battery pack of claim 1, further comprising a bus bar thermally contacting an electrode terminal of the at least one battery cell, wherein the fixation portion is fixed on the bus bar.

8. The battery pack of claim 7, wherein the bus bar electrically connects a pair of adjacent battery cells of the at least one battery cell.

9. The battery pack of claim 7, wherein the bus bar has a screw hole, and the battery pack further comprises a fastening member penetrating the fixation portion and fixed to the bus bar at the screw hole.

10. The battery pack of claim 7, wherein the bus bar has a pair of terminal holes into which electrode terminals of a pair of adjacent battery cells are inserted.

11. The battery pack of claim 10, wherein the fixation portion is fixed between the pair of terminal holes.

12. The battery pack of claim 11, wherein the fixation portion is fixed at a position that is closer to one of the pair of terminal holes than to the other of the pair of terminal holes.

13. The battery pack of claim 7, further comprising a voltage measurement wire connected to the electrode terminal to measure a voltage of the at least one battery cell.

14. The battery pack of claim 1, wherein the at least one battery cell comprises a plurality of battery cells, and the thermistor comprises thermistors arranged at respective pairs of adjacent battery cells of the plurality of battery cells.

15. The battery pack of claim 14, wherein the at least one battery cell comprises electrode terminals at first and second sides of the battery pack, the battery pack further comprises bus bars electrically connecting pairs of adjacent battery cells of the plurality of battery cells and arranged alternately at the first and second sides of the battery pack in an arrangement direction of the plurality of battery cells, and the thermistors are attached to the bus bars at either one of the first and second sides of the battery pack.

16. The battery pack of claim 1, wherein the at least one battery cell comprises a plurality of battery cells, and the battery pack further comprises:
a pair of end plates arranged at both ends in an arrangement direction of the battery cells;
a pair of side plates covering both sides of the battery cells and connected to the pair of end plates; and
a top plate arranged on surfaces of the battery cells including electrode terminals, the top plate being connected between the pair of end plates and between the pair of side plates.

17. The battery pack of claim 16, wherein the top plate comprises:
a base frame extending between the pair of end plates in the arrangement direction of the battery cells; and
first and second support frames extending from the base frame to respective first and second side plates of the pair of side plates.

18. The battery pack of claim 17, further comprising a plurality of bus bars configured to electrically connect the electrode terminals of adjacent battery cells of the plurality of battery cells,
wherein the first and second support frames extend in a space between the bus bars.

19. The battery pack of claim 16, wherein a wire guide is formed on the top plate to guide the temperature measurement wire.

20. The battery pack of claim 16, wherein at least one of the side plates comprises a boss member configured to attach a circuit board to which an extended end of the temperature measurement wire extending from the thermistor body is connected.
